(19) United States
(12) Patent Application Publication
(10) Pub. No.: US 2006/0126963 A1
(43) Pub. Date: Jun. 15, 2006

(54) Frame classification information providing device and program

(75) Inventors: Fumihiro Sonoda, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd., Kanagawa (JP)

(21) Appl. No.: 11/296,204

(22) Filed: Dec. 8, 2005

(30) Foreign Application Priority Data
Dec. 9, 2004 (JP) 2004-356655

(51) Int. Cl. G06K 9/36

(52) U.S. Cl. 382/276

(57) ABSTRACT

A photo movie is ordered by placing a memory card storing frame images into an order accepting device, and an operation screen appears on a touch panel display of the order accepting device. The operation screen includes a scenario selection screen and a frame assignment screen. The frame assignment screen displays the frame images read from the memory card and scene configuration information. The scene configuration information shows configuration of plural scenes of the photo movie, and each frame image is assigned to one of the scenes in the frame assignment screen. The order accepting device stores the assignment destination, as frame classification information, in the data file of each frame image. An image editing device creates the photo movie based on the frame classification information.

### BACKGROUND OF THE INVENTION

1. Field of the Invention

The present invention relates to a frame classification information providing device and program for adding frame classification information to still images in order to create a pseudo-movie from the still images.

2. Background Arts

Frame images (or still images) captured with a digital camera are often processed and edited to create a pseudo movie (hereinafter, “photo movie”), which gives the impression of movement just like the movies (see, for example, the Japanese patent laid-open publications No. 2003-125346 and No. 10-200843). The processing and editing may either be, for example, an electronic zooming process that crops and zooms in to a portion of a frame image, an electronic panning process that moves a cropping frame from end to end of a frame image to move the view point apparently, or an image composite process that synthesizes a frame image with decorative images. Such special effects (hereinafter, “effects”) are added to the still images and the photo movie is created.

Also, the above publication No. 10-200843 and some prior arts describe an image editing software for creating such photo movies (see, for example, “LiFE* with PhotoCinema” from Digitalstage inc., searched on Apr. 6, 2004, via the Internet, <URL:http://www.digitalstage.net/jp/product/life/index.html>). The photo movie is created based on an edit condition which specifies the name of frame images, the kind of effects, a playback sequence and so forth. The above mentioned image editing software has a manual mode, in which the edit condition is determined in detail by manual operation. Such a manual mode contributes to reflect a user's intention of the edit correctly to the photo movie but, at the same time, makes the editing operation difficult and complicated. Therefore, the image editing software of the “LiFE* with PhotoCinema” offers an automatic mode, where the photo movies are created only by selecting the frame images to be used. The editing operation could be easy in this automatic mode because the edit condition, except for a selection of the frame images, is automatically determined by a computer.

In this automatic mode, however, the software finds no difference between the selected frame images, and some of the frame images might be assigned to inappropriate scenes in the photo movie with inappropriate sequence. As a result, two unrelated frame images may be combined together, and the created photo movie could hardly tell the story of the event (i.e. a course of the event).

Any event has its own story. For example, travel will begin with preparation, and proceeds to an outward trip, sightseeing in the destination, and a return trip. Similarly, an athletic festival will follow an opening ceremony, morning athletic events, a lunch break, afternoon athletic events, and a closing ceremony. Telling the story of the event must be a critical factor for a pleasing photo movie.

### SUMMARY OF THE INVENTION

In view of the foregoing, an object of the present invention is to provide a frame classification information providing device and program which enables to create pleasing photo movies without any complicated editing operation.

To achieve the above object and other objects of the present invention, the frame classification information providing device includes an image data reader, a first memory, a display, a frame assigner, and a second memory. The image data reader reads out image data of the frame images stored in a data storage medium. The first memory previously stores at least scene configuration information of scenario information which determines an edit condition of the photo movie. And the scene configuration information specifies a configuration of scenes in the photo movie. The display shows scene categories which correspond to the scenes defined in the scene configuration information. The frame assigner assigns each frame image to one of the scene categories. The second memory stores information of the assignment scene category, as frame classification information, while correlating the frame classification information to image data of the frame image.

It is preferable for the display to show assignment areas of each of the scene categories and thumbnail images of the read frame images. The frame assigner moves each thumbnail image into one of the assignment areas so that the frame images are assigned to the scene categories. It is also preferable to prepare as many types of the scene configuration information as the scenario information. The frame classification information is possibly stored in an image file together with the image data.

Additionally, the frame classification information providing device may further include a communication interface for accessing an image editing device through a data bus, and a scene configuration information updater for automatically updating the scene configuration information based on forms of the scenario information stored in the image editing device.

The frame classification information providing program of the present invention includes the first and second reading steps, displaying step, and storing step. In the first reading step, image data of the frame images is read out from a data storage medium. In the second reading step, at least scene configuration information of scenario information is read out from a memory. The scenario information determines an edit condition of the photo movie, which is created by processing and editing frame images. And the scene configuration information specifies a configuration of scenes in the photo movie. In the displaying step, scene categories are displayed on a screen. The scene categories correspond to the scenes defined in the scene configuration information. In the storing step, when the frame image is assigned to one of the scene categories by a frame assigner, information of the assignment scene category is stored as frame classification information while correlated to image data of the frame image.

It is preferable to show assignment areas of each of the scene categories and thumbnail images of the read frame images in the displaying step. Each thumbnail image is assigned by the frame assigner to one of the assignment areas

Additionally, the frame classification information providing program may further include the accessing step for accessing an image editing device through a data bus, and updating step for automatically updating the scene configuration information based on forms of the scenario information stored in the image editing device.

According to the present invention, each frame image is assigned by the frame assigner to one of the scene categories, which correspond to the scenes of a photo movie and are displayed on the monitor screen based on the scene configuration information read out from the memory. And information of the assignment scene category, i.e. an assignment destination, is given to each frame image as frame classification information, which is correlated to the image data of each frame image for storage. Therefore, the editing operation to the photo movie is hardly complicated. In addition, since the assignment destination is specified according to customer's intention, a created photo movie can be pleasing.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is an explanatory view of a photo movie creating service;

FIG. 2 is a block diagram of an order accepting device and an image editing device;

FIG. 3 is an explanatory view of special effects applied to photo movies;

FIG. 4 is an explanatory view of a scenario file for the photo movie;

FIG. 5 is an explanatory view of storage of frame classification information;

FIG. 6 is an explanatory view of a data storage structure of DVD media;

FIG. 7 is an explanatory view of a scenario selection screen;

FIG. 8 is an explanatory view of a frame assignment screen;

FIG. 9 is an explanatory view showing a classification of frame images into scene categories of athletic festival;

FIG. 10 is an explanatory view showing a classification of frame images into scene categories of travel;

FIG. 11 is a flow chart of an order accepting procedure for the photo movie;

FIG. 12 is a flow chart of a photo movie creating procedure;

FIG. 13 is an explanatory view of the scene category with a hierarchical structure; and

FIG. 14 is an explanatory view of an order of the photo movie via the internet.

### DESCRIPTION OF THE PREFFERED EMBODIMENTS

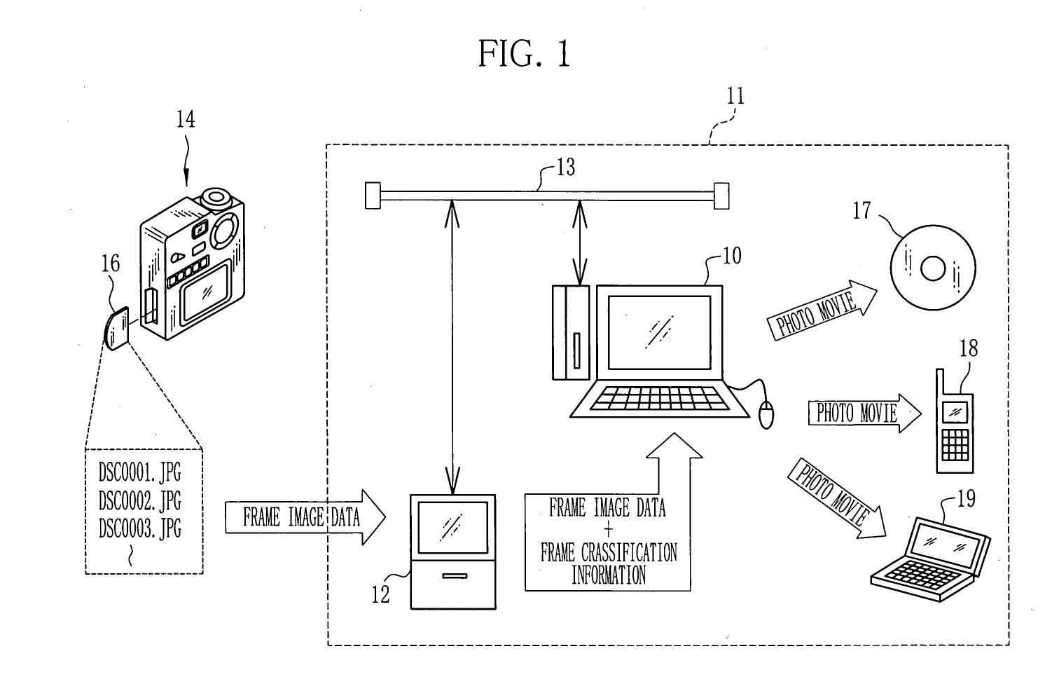

Referring to FIG. 1, an image editing device 10 is installed at, for example, a DPE shop 11 which provides a photo printing service. The image editing device 10 will process and edit captured still images (hereinafter “frame images”) to create a photo movie. Typically, the photo movie is generated as a movie file such as MPEG and recorded to removable media such as DVD 17 for delivery. Also, the generated photo movie can be downloaded onto a cellular phone 18 and a mobile terminal 19 such as a notebook PC or a PDA (Personal Digital Assistant).

The image editing device 10 is connected through a data bus 13 to an order accepting device 12, or a frame classification information providing device, that accepts an order for a photo movie creation. To make an order for photo movie, a customer places a memory card 16 storing the data of the frame images (DSC0001.JPG-DSC000X.JPG) captured with a digital still camera 14 into the order accepting device 12 at the DPE shop 11. The order accepting device 12 performs classification information providing processing, as well as the management of the order, to classify the accepted frame images. The classification information providing processing is a preparation step for a photo movie creating processing performed by the image editing device 10, and frame classification information for assigning each frame image to one of the scenes of a photo movie is provided in this processing. The frame images are classified by the customer operating to the order accepting device 12, and the frame classification information is given to each of the classified frame images. The frame classification information is sent together with the image data to the image editing device 10. And the image editing device 10 assigns each image data to one of the scenes to create the photo movie.

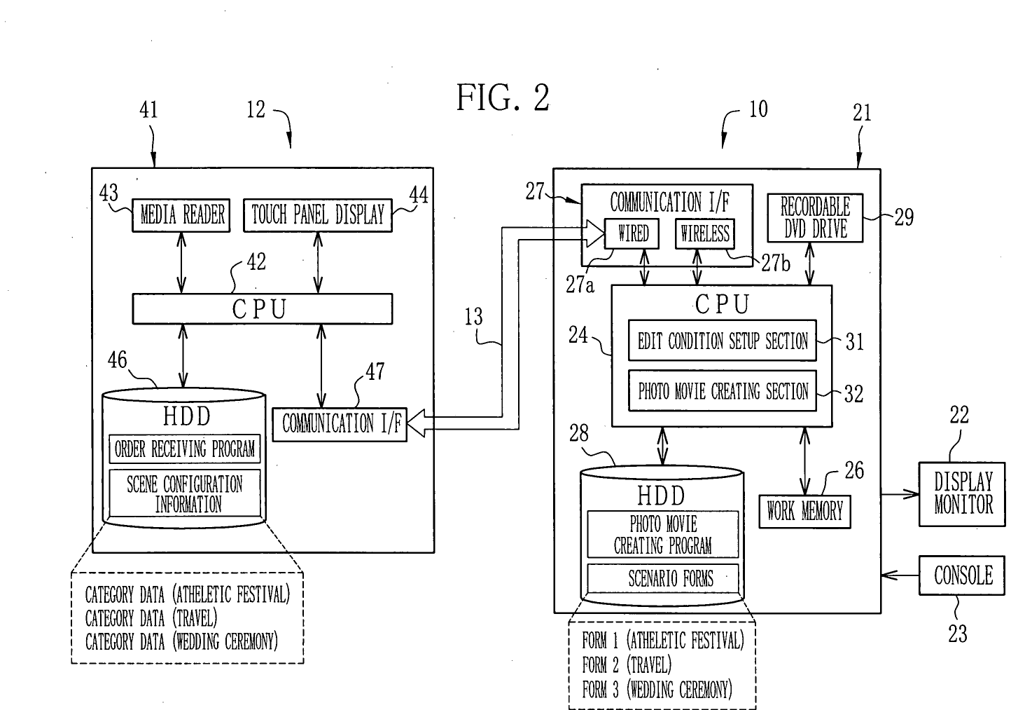

As shown in FIG. 2, the image editing device 10 includes a main unit 21, a monitor display 22, and a console 23. The main unit 21 is, for example, a general personal computer or work station that installs an image editing program. The main unit 21 is composed of a CPU 24, a work memory 26, a communication interface 27, a hard disk drive (HDD) 28, and a recordable DVD drive 29. The CPU 24 controls every component of the device in accordance with an operating system.

The communication interface 27 is provided with a wired interface 27a that supports USB or IEEE1394 and a wireless interface 27b that supports IEEE802.11 series or Bluetooth, establishing a data communication between the image editing device 10 and any external equipment. The wired interface 27a is connected to a LAN cable as the data bus 13. If the order accepting device 12 is placed remote from the image editing device 10, they are linked to each other through the internet or the wide area network. The wireless interface 27b establishes the data communication to the cellular phone 18 and the mobile terminal 19.

The monitor display 22 displays an operation screen of the image editing program and the read frame images. The console 23 enters commands to the image editing device 10 and includes a mouse, a keyboard, and some such. An operator can work on the image editing device 10 using these monitor display 22 and the console 23.

The recordable DVD drive 29 writes data to the DVD 17. Nonetheless, the storage medium is not limited to DVD, and any storage medium such as CD or any prospective next-generation storage medium such as Blu-ray (registered trademark) may also be used. Additionally, this drive can be configured to handle a variety of storage media so as to meet a customer's requirement.

The CPU 24 downloads the image editing program from the HDD 28 onto the work memory 26 and executes the processing steps described in the program. The CPU 24 will thereby function as an edit condition setup section 31 and a photo movie creating section 32.

The HDD 28 contains an operating system and the image editing program run by the CPU 24. The HDD 28 also contains various accompanying data used in the image editing program. The accompanying data includes later described scenario files of the photo movie and decorative images to decorate the frame images. The decorative images are synthesized with the frame image and gives charm to the back ground or any one point of the image. The decorative images include a mask image to cover an unnecessary portion of the image and a template image that has an illustration and a framed area to surround the image.

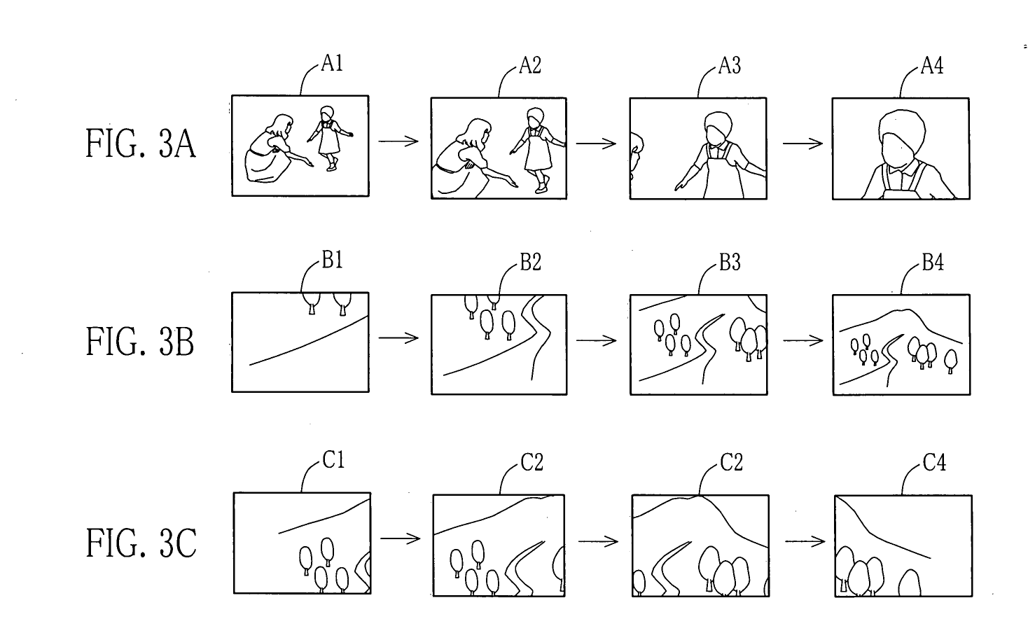

In the photo movies, the frame images are added with such effects as the electronic zooming process and the electronic panning process. A scene A in FIG. 3A begins with a frame A1 of a parent and a child, proceeds to a frame A2 and a frame A3 of the child's face zoomed up gradually, then reaches a frame A4 the close-up shot of the child's face. The scene A is created through the electronic zooming process of placing a zoom point at a certain part of the original image (the frame A1), cropping out the partial images of different magnification (the frames A2 to A4), and joining these images together.

A scene B in FIG. 3B begins with a frame B1 of a ground surface and a road, then gradually zooms out to reach a frame B4 of a long distance view of a mountain which lies ahead the road. In the same process as the scene A, the scene B are created of placing a zoom point at a certain part of an original still image (the frame B4), cropping out the partial images of different magnification (the frames B1 to B3), and joining the images together. Since the scene B is zooming out from the zoom point, contrary to the scene A which is zooming in to the zoom point, the first frame B1 has the highest magnification while the last frame B4 has the same magnification as the original image.

A scene C in FIG. 3C appears as if a camera is moving horizontally to obtain a panoramic effect. The scene C begins with a frame C1 showing the left foot of a mountain as the main subject, proceeds to a frame C2 and a frame C3 showing the mountain in the center of a screen, then reaches a frame C4 showing the right foot of the mountain. The scene C are created by moving a cropping point from left to right to crop some parts of an original still image, which captures a long distance view of the whole mountain. Then, the cropped images (the frames C1 to C4) are joined together. In the above examples, every scene is comprised of four frames for the sake of simplicity, but in reality each scene contains a significant number of frames displayed at a frame rate of, for example, thirty frames per second. The plural scenes with the special effects applied thereto are joined together to create a photo movie.

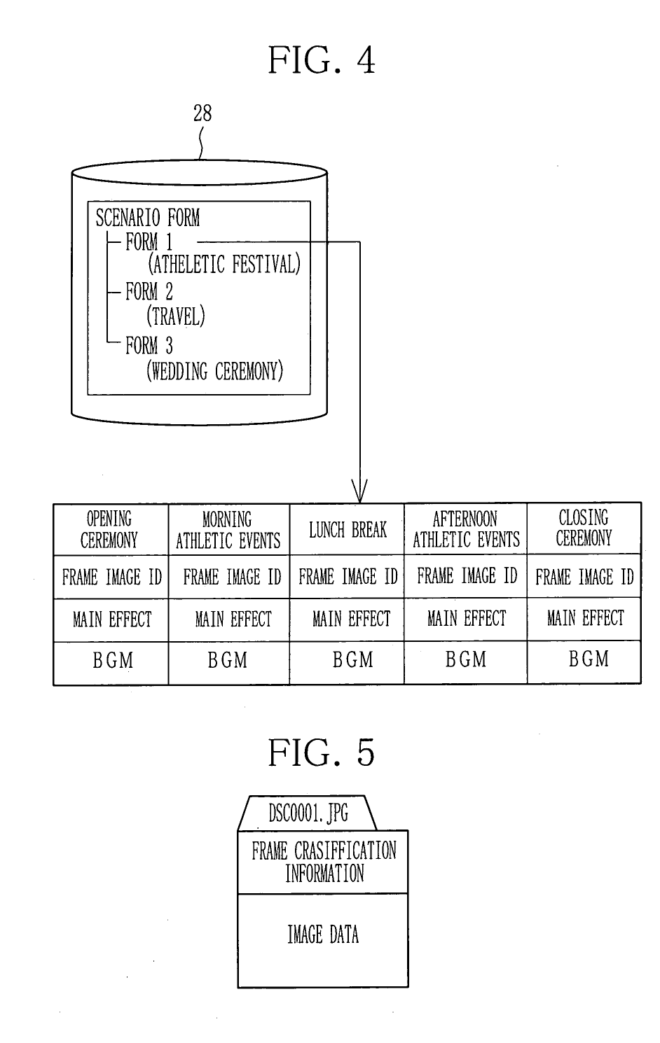

The edit condition of the photo movie is written in, for example, a scenario file, in which the edit condition is defined along time stamps of each frame. The HDD 28 contains forms of various scenarios (i.e. scenario forms) that define the basic edit condition for each event such as an athletic festival, travel, or a wedding ceremony. As shown in FIG. 4, the scenario file contains ID of the frame image to be used, the type of effects, BGM, and decorative images to decorate the frame image.

Also, the scenario file carries scene configuration information which determines major scenes of the photo movies. The scenario file of “athletic festival”, for example, divides a photo movie into five major scenes as “opening ceremony”, “morning athletic events”, “lunch break”, “afternoon athletic events”, and “closing ceremony”. And scene categories corresponding to these major scenes are defined as scene configuration information.

The ID of the frame image is assigned to the scene category corresponding to the intended scene. Because the frame images are classified into the scene categories, they can be used in appropriate scenes and any unexpected scene is never created to contain the frame images of, for example, both the opening ceremony and the lunch break.

The scenario forms previously determine a main effect and BGM of each scene category. As for the scene category of, for example, the “opening ceremony” which is supposed to have the frame image of the whole festival site, the main effect is the panning process suitable to show the entire festival site and convey the excitement of the site. And cheerful music is used as the BGM. As for the scene categories of both “morning athletic events” and “afternoon athletic events”, the main effect is the zooming process in order to focus on a specific athlete (the child of a photographer, for example) in a game such as a tug-of-war or a relay race. One exemplary method to place the zoom point on a specific person would be a face extraction technique. The BGM of these scenes will be up-tempo music to give punch to the scenes. By determining the main effect and BGM for each scene category in this manner, the created photo movie will tell the story of the event.

The edit condition setup section 31 reads out the selected scenario form from the HDD 28, and assigns the IDs of the frame images to the scene categories defined in the read scenario form. As described later, the selection of the scenario form and the assignment of the frame images to the scene categories are carried out based on classification information (or frame classification information) given to the frame images by the order accepting device 12. The edit condition is determined accordingly and the scenario file is created. Based on this scenario file, the photo movie creating section 32 creates the photo movie, which is then written to the DVD 17 by the recordable DVD drive 29.

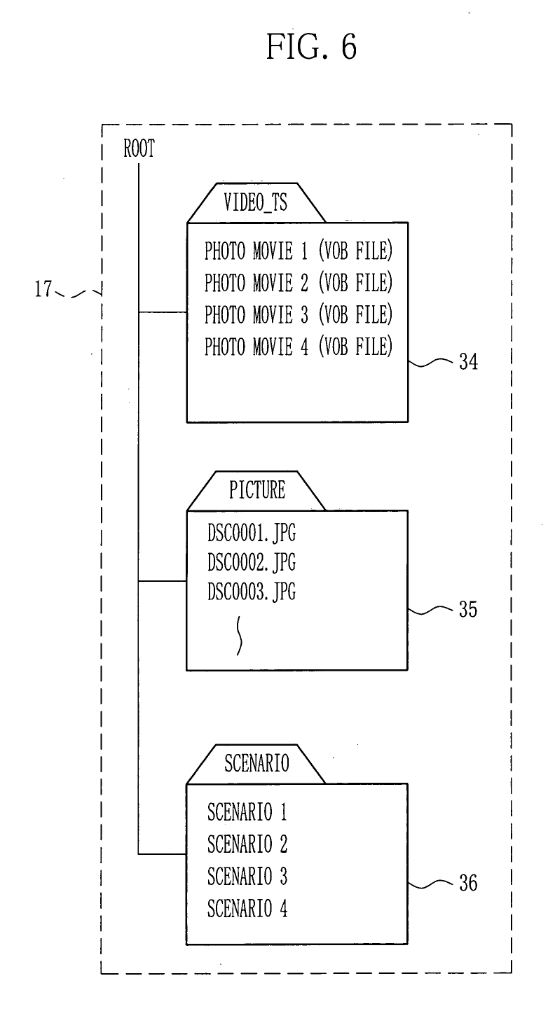

Referring to FIG. 6, the DVD 17 stores data, for example, in the DVD-Video format which is supported by most commercial DVD players. The created photo movie is stored as VOB file in a VIDEO_TS folder 34. The VOB file is an alteration of the movie file of MPEG2, the standard compression format for movies, modified to support the DVD-Video format.

As well as the created photo movies, the DVD 17 will store image files (DSC0001.JPG . . . ) of the frame images used in the photo movies and the scenario files specifying the edit condition of the photo movies respectively in a picture folder 35 and a scenario folder 36.

Since each photo movie file is made as a movie file independent of the scenario files, it does not need the scenario files for playback. The reason to store the scenario files along with the photo movie files is to enable a user to re-edit the scenario files so that other new photo movies can be easily created. Also, the image files of the frame images can be used for printing, allowing to obtain a high definition printout of the favorite frame of the photo movie. Because the pixels of each frame of the photo movie are not sufficient for printing, a high definition printout is hardly obtained from the data of the photo movie. On the other hand, the frame images in the image file have enough pixels, and it is therefore possible to obtain the high definition printouts of the favorite scenes.

The created photo movie is usually output to the DVD 17, but it may be output to the cellular phone 18 and the mobile terminal 19 at a customer's request. The wireless interface 27b sends the data of photo movie to the cellular phone 18 and the mobile terminal 19 and, in this case, it is preferable to determine the number of pixels and frames of the photo movie according to the memory size of the cellular phone 18 or the mobile terminal 19 so that the photo movie data has a smaller data size than when output to the DVD 17.

Nowadays, many of the cellular phone 18 and the mobile terminal 19 have a camera function. Therefore, the order accepting device 12 may be provided with a wireless interface to receive the data of frame images captured with these mobile devices for the creation of the photo movies.

The order accepting device 12 includes a CPU 42, a media reader 43, a touch panel display 44, a HDD 46, and a communication interface 47, all of which are built into a main unit 41. Every component of the order accepting device 12 is under the control of the CPU 42. The touch panel display 44 displays an operation screen and the frame images and enters the commands and selection from a user (or customer) through the screen. A customer will work on the order accepting device 12 through the touch panel display 44 to make an order for photo movie.

The media reader 43 reads out the data in the memory card 16 to download the frame images to be used in the photo movie. The memory card 16 is inserted to a card slot 43a of the media reader 43, which is provided on the front face of the main unit 41. The communication interface 47 is connected to the data bus 13 for data communication with the image editing device 10.

The HDD 46 previously stores program data such as an operating system and an order receiving program. The CPU 42 reads out the order receiving program from the HDD 46 and performs an order accepting process.

At the time of the order, each frame images is assigned to the scenes of the photo movie. This assignment of the frame images is made by the customer operating to the order accepting device 12. The HDD 46 stores the same scene configuration information as contained in the scenario forms in the image editing device 10. The scene configuration information is composed of category data that corresponds to the scene category of each scenario form. That is, there are the category data of “athletic festival”, “traveling”, and “wedding ceremony”, the same variations as the scenario form stored in the HDD 28.

The category data is displayed on the touch panel display 44. As watching and working on the screen of the touch panel display 44, the customer assigns the frame images to the scenes, and each frame image is thereby classified into one of the scene category. Information of the assignment scene category, or assignment destination, is correlated to the frame image and stored as frame classification information.

As shown in FIG. 5, the frame classification information is stored in the image file as, for example, the supplemental information of the image data (DSC0001.JPG). The frame classification information would be stored in a tag field defined by the EXIF standard, a common file format of digital still cameras. Based on the frame classification information, the image editing device 10 recognizes which frame image is assigned to which scene of which scenario.

The order accepting device 12 temporarily stores the image data of the frame images in the HDD 46 and sends it to the image editing device 10. The image data may be sent to the image editing device 10 for each order, or the image data for many orders may be sent all at predetermined time periods.

The category data in the HDD 46 of the order accepting device 12 should correspond to the scenario form in the HDD 28 of the image editing device 10, and it is therefore updated every time the scenario form is updated.

The order accepting device 12 will check at regular intervals if the scenario form is updated in the imaging device 10 (the HDD 28), and when detecting the scenario form has been updated, it extracts the category data from the updated scenario form and automatically updates the category data in the order accepting device 12 (the HDD 46). Whether or not the scenario form is updated can be detected by, for example, reading out the date of the scenario forms in the HDD 28 through the data bus 13 and comparing this read out date with the date of the category data in the HDD 46. When the date of the category data precedes the date of the scenario form, the CPU 42 of the order accepting device 12 regards that there is an update and extracts the category data from the scenario form. The update check to the scenario forms is a regular routine performed, for example, once a day on the start up of the order accepting device 12. Certainly, the frequency and timing of the update check can be determined as appropriate.

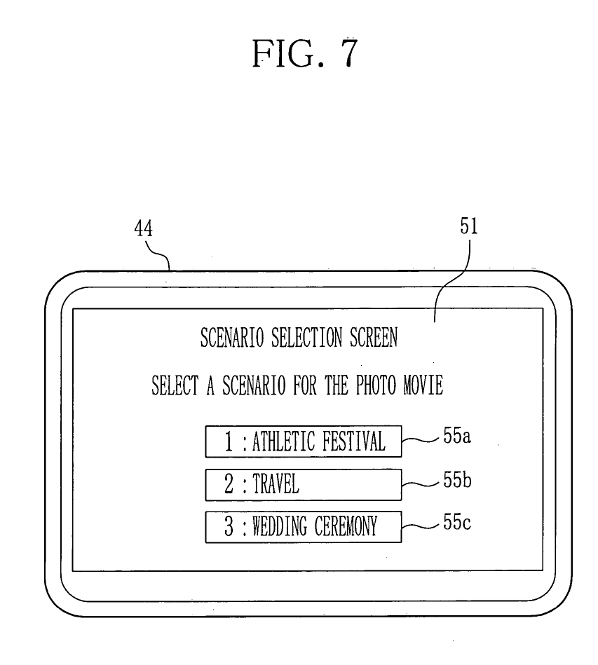

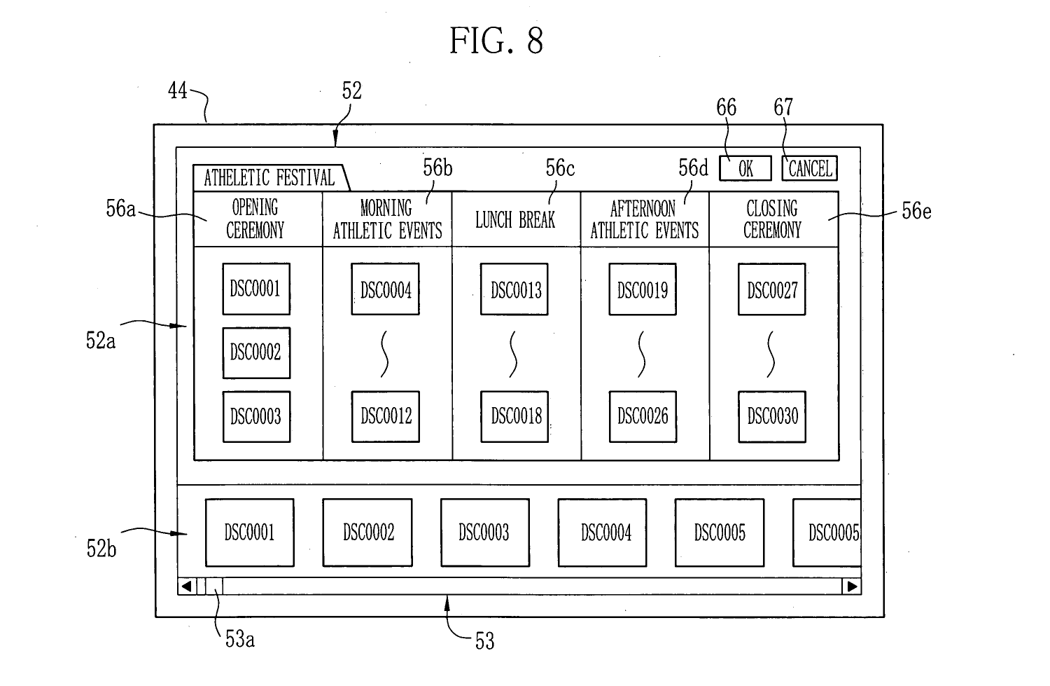

In FIG. 7 and FIG. 8, when the item of photo movie order is selected on the initial screen, a scenario selection screen 51 appears as depicted in FIG. 7. The scenario selection screen 51 shows a message as “Select a scenario for the photo movie” and a list of the titles 55a-55c for the category data (“athletic festival”, “traveling”, “wedding ceremony”) previously stored in the HDD 46. The customer points the intended title 55a to select the scenario.

When the scenario is selected, a frame assignment screen 52 appears as depicted in FIG. 8. The frame assignment screen 52 includes a main display area 52a occupying most of the screen and a sub display area 52b elongated in the lateral directions below the main display area 52a. In the sub display area 52b, six thumbnails of the frame images (file name: DSC0001-000X) stored in the memory card 16 are displayed at a time. If the memory card 16 contains more than six frame images, a scroll bar 53 extending along the lateral direction will appear below the sub display area 52b. A slider 53a on the scroll bar 53 is slid to move the view of the sub display area 52b in the lateral directions. In accordance with the amount of the move, other thumbnail images are scrolled to show up in the sub display area 52b.

The main display area 52a is divided into narrow strips of assignment areas 56a-56e. The assignment areas 56a-56e correspond respectively to each of the scene categories of the selected scenario. In FIG. 8, the scenario of the athletic festival is selected, and the main display area 52a is divided into five areas, which correspond respectively to the scene categories of “opening ceremony”, “morning athletic events”, “lunch break”, “afternoon athletic events”, and “closing ceremony”. Uppermost tags in the assignment areas 56a-56e show the titles of their corresponding scene categories. The scene categories are arranged from left to right on the screen following the playback sequence set in the scenario. This arrangement helps the customer to understand the scene configuration of the selected scenario. The assignment areas 56a-56e are used to assign the frame images read from the memory card 16 to one of the scenes.

To assign the frame images, the customer points a frame image in the sub display area 52b and drags it to one of the assignment areas 56a-56e that corresponds to the intended scene category. In the sub display area 52b and the assignment areas 56a-56e, the frame images are reproduced with their file names displayed. Thereby, the customer can see the contents of the images when assigning them.

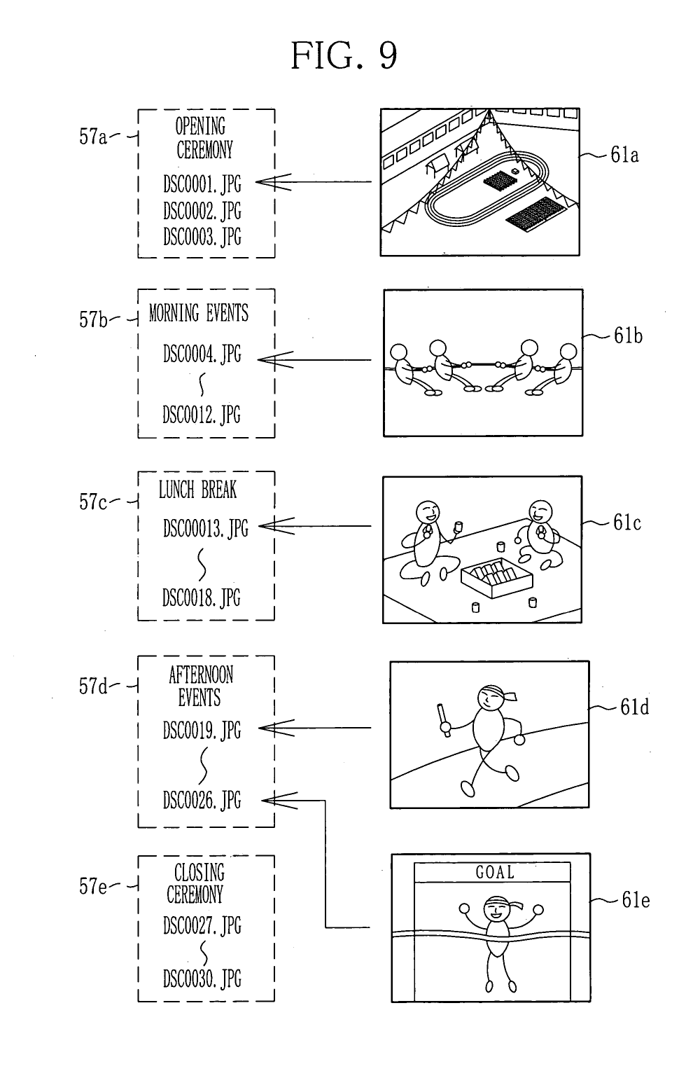

Through this frame assignment operation, in FIG. 9, a frame image 61a of the opening ceremony is assigned to a scene category 57a of the “opening ceremony”, a frame image 61b of a tag-of-war in the morning is assigned to a scene category 57b of the “morning athletic events”, a frame image 61c of the lunch break is assigned to a scene category 57c of the “lunch break”, and both frame images 61d, 61e of a relay race in the afternoon are assigned to a scene category 57d of the “afternoon athletic events”.

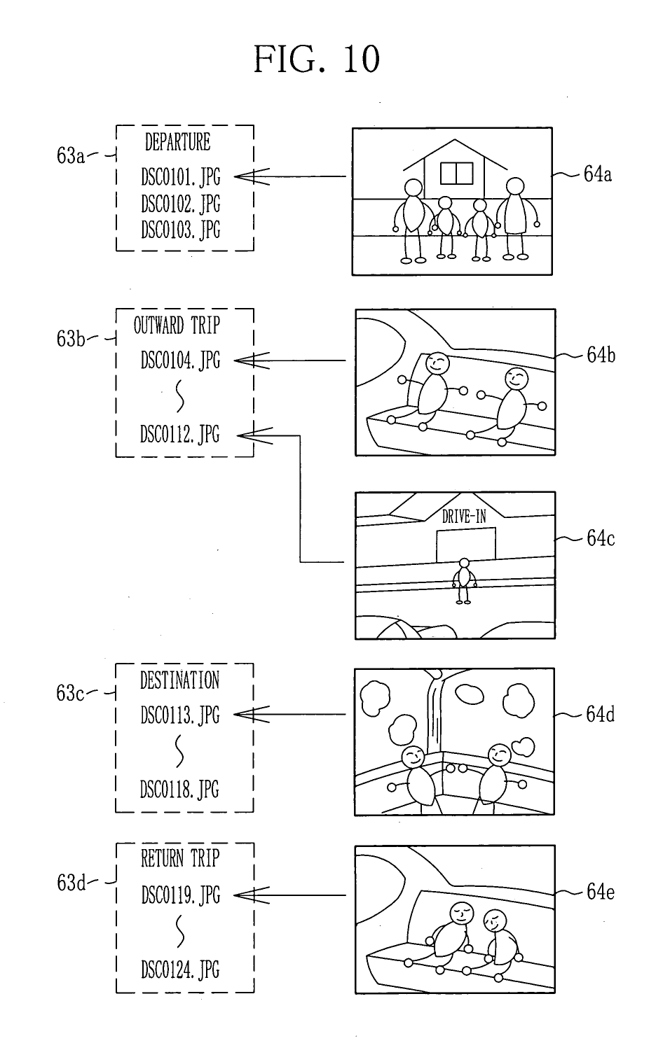

Similarly, the scenario file of travel previously defines the scene categories 63a-63d of, for example, “departure”, “outward trip”, “destination”, and “return trip”, as shown in FIG. 10. When the scenario file of travel is selected, the frame assignment screen 52 displays the assignment areas to correspond to these scene categories 63a-63d. A frame image of family in front of the house at departure is assigned to the scene category 63a of “departure”. A frame image 64b of the children in the car heading to the destination and a frame image 64c of a drive-in on the way are assigned to the scene category 63b of the “outward trip”, while a frame image 64d of the children playing at the destination is assigned to the scene category 63c of “destination”. And a frame image 64e of the children sleeping in the car going home is assigned to the scene category 63d of “return trip”.

When a frame image is mistakenly assigned to an improper assignment area, this frame image can be moved by dragging it from the once assigned area to any intended assignment area. Pressing an OK button 66 confirms the assignment of the frame images. Alternatively, a cancel button 67 is pressed to change the scenario or to stop making the order. Following on the confirmation of the assignment, the frame classification information is stored in the image files of the frame images and written together with the image data to the HDD 28. The order for the photo movie is completed at this stage.

Although the above embodiment uses the touch panel display for the scenario selection operation and the scene category specification operation, an operation panel with various buttons for such operations may be provided separately from the display.

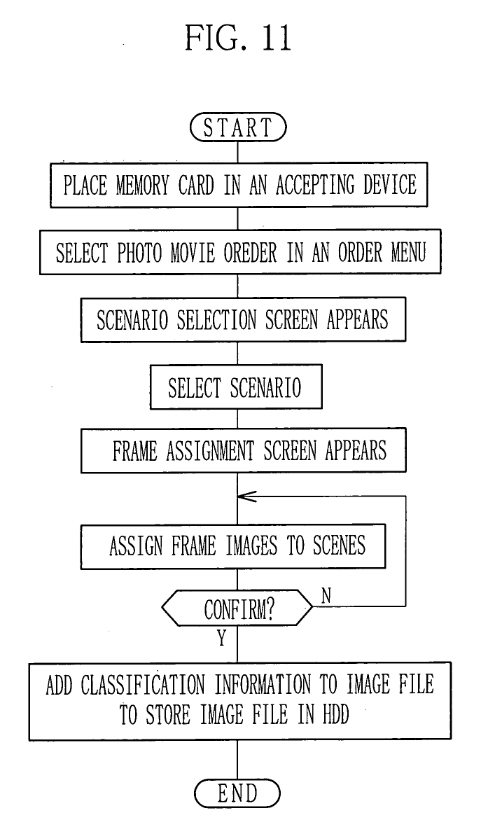

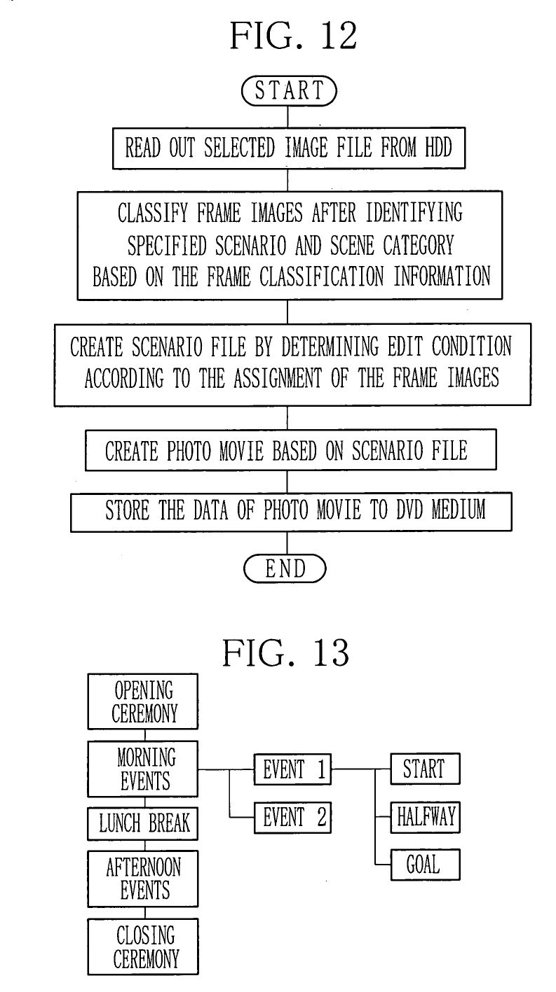

Next, the operation of the above embodiment is now explained with reference to flowcharts of FIG. 11 and FIG. 12. To make an order for photo movies, a customer places the memory card 16 storing the frame images into the order accepting device 12 and selects the item of photo movie order from the order menu displayed on the touch panel display 44. Then, the scenario selection screen 51 appears. The customer selects one of the scenario titles in the scenario selection screen 51, and the frame assignment screen 52 appears on the touch panel display 44.

In the frame assignment screen 52, the sub display area 52b displays the thumbnails of the frame images stored in the memory card 16, while the main display area 52a displays the assignment areas that correspond to the scene categories of the selected scenario. The customer selects a frame image in the sub display area 52b and drags it to the assignment area corresponding to the intended scene category. This operation is repeated to all the frame images to be used for the photo movie to assign them to one of the scene categories.

When the frame assignment is finished, the OK button 66 is pressed to confirm the assignment. In response to the press of the OK button 66, the frame classification information is written to the HDD 46 together with the image data of the frame images. Thereby, the ordering of the photo movie is accepted. The accepted data is sent from the order accepting device 12 through the data bus 13 to the image editing device 10 and stored in the HDD 28.

When the operator directs the photo movie creation, the image editing device 10 read out the image files of the order from the HDD 28. Then, the edit condition setup section 31 identifies the intended scenario based on the frame classification information in these image files, and reads out the corresponding scenario form from the HDD 28. The frame images are assigned to one of the scene categories of the scenario form and a scenario file is produced. The operator makes some changes to the given edit condition, where needed, to confirm the edit condition.

When the edit condition is determined, the photo movie creating section 32 follows the scenario file to create the photo movie. The photo movie will be edited on a scene category basis. Since the frame images have been classified into the appropriate scene categories, there is no chance of unrelated frame images appearing in the same scene or no chance of related frame images appearing in the separate scenes. Additionally, since the scenes will proceed along a time line and the main effect as well as BGM can be selected on each scene category, a dynamic scene change can be expected. The photo movie created in this way is able to tell the story of the event sufficiently, becoming more pleasing one. Moreover, the frame images are automatically classified according to the frame classification information, and any complicated operation is not required of the operator.

In the photo movie creating service where the photofinishers create the photo movies on order, a critical factor for upgrading the product is how well to reflect the photographer's intention in the photo movie. However, it is very difficult for the photofinishers to comprehend such an intention when classifying the frame images. In contrast, when using the order accepting device 12, it is the photographer himself that classifies the frame images. Therefore, the frame images are appropriately classified and consequently the quality of the photo movie creation service will be upgraded.

Although, in the above embodiment, the category data is consisted only of the scene categories on the same hierarchical level, the scene categories may have a multi hierarchical structure. In FIG. 13, for example, the scene category of “morning athletic events” has sub categories of “athletic event 1” and “athletic event 2”, and the “athletic event 1” also has sub categories of “start”, “halfway”, and “goal”. This detailed classification of the scene category enables a finer edit operation, and leads to upgrade the photo movie.

In the above embodiment, the customer selects the scenario and assigns the frame images to the scene categories. Furthermore, it may be possible to assign a frame image to a climax scene of the photo movie. In FIG. 9, for example, the frame image 61e showing the goal of a race seems appropriate for the climax scene of the “athletic festival” photo movie. As the climax scene, the frame image 61e would be displayed longer and appear more times than other frame images, and the created photo movie can thereby be more expressive.

The frame image may be assigned to the climax scene by, for example, pressing or checking a button or a check box displayed in the operation screen on the touch panel display 44. Alternatively, it may be assigned manually to the climax scene by the operator of the image editing device 10.

As well as the climax scene, the frame images may be assigned to any specific scenes such as an opening scene, a title scene, and an ending scene of the photo movie. In this case, the frame images will be inserted in the specific scenes regardless of the order of capturing. It is preferable to edit the opening scene and the title scene so that the date of the event and the title of the photo movie are displayed.

In the above embodiment, the scenario forms determine the main effect of each scene category. Additional special effects may be selected according to the content of the image. Specifically, a group shot that captures several people and a snap shot that captures a landscape should be edit differently. For example, the group photo will be panned and zoomed in to the faces of every people and then zoomed out to capture the whole group. On the other hand, the snap shots will be edited mainly with the zooming process while avoiding the use of the panning process as much because the photographic subjects tend to gather at one spot in the snap shot.

Often, family photos such as the frame image 64a in FIG. 10 tend to include similar frame images because, mostly of the case, a father firstly captures the image of a mother and children, and then the mother takes turn to capture the image of the father and the children. When such similar images are edited with the zooming process, the same children will appear many times and the photo movie becomes uninteresting. In this particular case, an image analysis technique should be incorporated to distinguish the similarity of these frame images. Then the zooming process is applied to all the photographed persons in the first image while it is applied to the person in the second image not showing in the first image (either the father or mother in this embodiment).

In the above embodiment, the frame classification information and the image data are stored together in the same file. However, it is not necessarily to store the two in the same file as long as they are correlated to each other. When the frame classification information and the image data are stored in the separate files (the jpg and the txt files), a single text file is created as a frame classification information file, which stores the frame classification information (i.e. scene categories) of all the image data. The image editing apparatus need only access to the frame classification information file to read out the frame classification information of as many image data. Furthermore, when the frame classification information and the image data are separately stored, there is no need to modify the image file in common format (the EXIF format, for example).

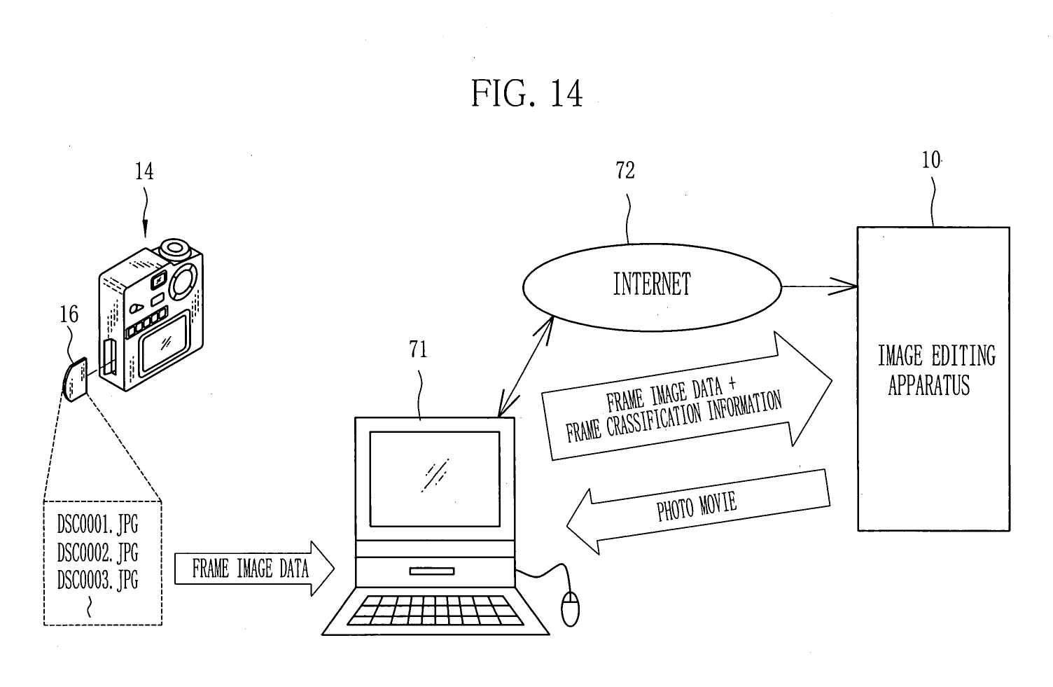

In the above embodiment, the order accepting device is placed at the DPE shops or the like. It is also possible to install a customer's personal computer (PC) 71 with the order accepting program of the present invention, as shown in FIG. 14, so that the frame classification information can be provided from the PC 71. In this case, the operation screens such as the scenario selection screen and the frame assignment screen are displayed on the monitor display of the PC 71 at the startup of the order accepting program on the PC 71. As watching these screens, the customer uses a keyboard and a mouse of the PC 71 to assign the frame images. Responding to this frame assignment, the PC 71 adds the frame classification information to the image data of each frame image. When the assignment is completed, the frame classification information and the image data are sent to the image editing device 10 via the Internet 72. The image editing device 10 creates a photo movie based on the received data and sends the created photo movie to the PC 71.

Alternatively, the frame classification information providing program of the present invention may be installed in, for example, an external module (such as a cradle device) detachable to the digital still cameras. In this case, the assignment of the frame images is carried out using a home television as the monitor display for the operation screen.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. A frame classification information providing device for processing and editing captured frame images to create a photo movie, comprising:
an image data reader for reading out image data of the frame images stored in a data storage medium;
a first memory for previously storing at least scene configuration information of scenario information which determines an edit condition of the photo movie, the scene configuration information specifying a configuration of scenes in the photo movie;
a display for displaying scene categories which correspond to the scenes defined in the scene configuration information;
a frame assigner for assigning each frame image to one of the scene categories; and
a second memory for storing information of the assignment scene category as frame classification information while correlating the frame classification information to image data of the frame image.

2. A frame classification information providing device as claimed in claim 1, wherein the display shows assignment areas of each of the scene categories and thumbnail images of the read frame images, wherein the frame assigner moves each thumbnail image into one of the assignment areas so that the frame images are assigned to the scene categories.

3. A frame classification information providing device as claimed in claim 1, wherein the scene configuration information is prepared as many types as the scenario information.

4. A frame classification information providing device as claimed in claim 1, wherein the frame classification information is stored in an image file together with the image data.

5. A frame classification information providing device as claimed in claim 1, wherein the scene categories have a hierarchical structure and each scene category contains a plurality of sub categories.

6. A frame classification information providing device as claimed in claim 1, wherein the display is a touch panel display which enters operation commands through a screen.

7. A frame classification information providing device as claimed in claim 1, further comprising:
a communication interface for accessing an image editing device through a data bus, the image editing device storing forms of the scenario information; and
a scene configuration information updater for automatically updating the scene configuration information based on the forms of the scenario information.

8. A frame classification information providing program for operating a computer to process and edit captured frame images to create a photo movie, comprising the steps of:
reading out image data of the frame images from a data storage medium;
reading out from a memory at least scene configuration information of scenario information which determines an edit condition of the photo movie, the scene configuration information specifying a configuration of scenes in the photo movie;
displaying scene categories on a screen, the scene categories correspond to the scenes defined in the scene configuration information; and
when the frame image is assigned to one of the scene categories by a frame assigner, storing information of the assignment scene category as frame classification information while correlating the frame classification information to image data of the frame image.

9. A frame classification information providing program as claimed in claim 8, wherein the displaying step includes showing assignment areas of each of the scene categories and thumbnail images of the read frame images, and wherein each thumbnail image is assigned by the frame assigner to one of the assignment areas.

10. A frame classification information providing program as claimed in claim 8, wherein the frame classification information is stored in an image file together with the image data.

11. A frame classification information providing program as claimed in claim 8, further comprising the steps of:
accessing an image editing device through a data bus, the image editing device storing forms of the scenario information; and
automatically updating the scene configuration information based on the forms of the scenario information.
